(19) United States
(12) Patent Application Publication
(10) Pub. No.: US 2025/0206013 A1
(43) Pub. Date: Jun. 26, 2025

(54) PRINTING APPARATUS, CONTROL METHOD OF PRINTING APPARATUS, AND NON-TRANSITORY AND COMPUTER-READABLE MEDIUM STORING CONTROL PROGRAM OF PRINTING APPARATUS

(71) Applicant: BROTHER KOGYO KABUSHIKI KAISHA, Nagoya (JP)

(72) Inventors: Shuhei SUZUKI, Nagoya (JP); Tatsuya MIYASAKA, Nagoya (JP); Hiroya OKUWA, Kariya (JP); Taiki TANAKA, Yokkaichi (JP); Kazunari MATSUURA, Komaki (JP)

(73) Assignee: BROTHER KOGYO KABUSHIKI KAISHA, Nagoya (JP)

(21) Appl. No.: 18/982,315

(22) Filed: Dec. 16, 2024

(30) Foreign Application Priority Data
Dec. 26, 2023 (JP) 2023-219320

(51) Int. Cl. B41J 2/005; B41F 16/02; B41J 2/045

(52) U.S. Cl. CPC B41J 2/0057; B41F 16/02; B41J 2/04541; B41J 2/04586

(57) ABSTRACT

A printing apparatus includes: a head configured to eject an ink having a sublimating property; and a controller. The controller is configured to control the head so as: to execute ejecting the ink from the head to a medium based on image data and in accordance with a print mode including first and second print modes, an usage amount of the ink in the second print mode is smaller than that in the first print mode, and in a case where the print mode is the second print mode, to execute outputting, as a transfer condition for transferring a print image printed on the medium to a transfer medium, a second transfer condition rather than a first transfer condition, a transfer energy for transferring the print image from the medium to the transfer medium being greater in the second transfer condition than in the first transfer condition.

### REFERENCE TO RELATED APPLICATIONS

This application claims priority from Japanese Patent Application No. 2023-219320 filed on Dec. 26, 2023. The entire content of the priority application is incorporated herein by reference.

### BACKGROUND ART

A control information generating apparatus is known which generates thermal transfer control information for heating a printed matter printed on a first medium based on image data, and for thermally transferring the printed matter to a second medium. The thermal transfer control information includes a transfer temperature and a transfer time as a transfer condition based on the amount of an ink supplied for printing the printed matter.

### SUMMARY

According to the control information generating apparatus of the conventional technique as described above, as the amount of the ink supplied for printing the printed matter is greater, the transfer temperature is higher and the transfer time is longer. However, under such a transfer condition, a printed matter in a print mode with a small amount of the ink is not thermally transferred to the second medium sufficiently, resulting in a decrease in the image quality of a transferred matter transferred onto the second medium, in some cases.

The present disclosure aims to provide a technique which contributes to reducing the decrease in the image quality of an image transferred to a transfer medium.

A printing apparatus according to the present disclosure includes: a head configured to eject an ink having a sublimating property; and a controller. The controller is configured to control the head so as to execute ejecting the ink from the head to a medium based on image data and in accordance with one mode selected from a print mode including a first print mode and a second print mode. An usage amount of the ink in the second print mode is smaller than an usage amount of the ink in the first print mode.

Further, in a case where the one mode selected from the print mode is the second print mode, the controller is configured to execute outputting, as a transfer condition for transferring the print image printed on the medium to a transfer medium, a second transfer condition rather than a first transfer condition. A transfer energy for transferring the print image from the medium to the transfer medium is greater in the second transfer condition than in the first transfer condition.

According to the present disclosure, the print image formed on the medium by ejecting the ink from the head to the medium based on the image data and in accordance with the second print mode uses the amount of the ink smaller than the amount of ink used in the first print mode. With respect to this, the second transfer condition is output as the transfer condition for transferring the print image to the transfer medium. In the second transfer condition, the transfer energy for transferring the print image from the medium to the transfer medium is greater than the transfer energy in the first transfer condition. Therefore, the small amount of the ink in a case where the print image is transferred from the medium to the transfer medium is compensated, and thus the decrease in the image quality of the transferred print image can be reduced.

### BRIEF DESCRIPTION OF DRAWINGS

FIG. 1 is a schematic diagram depicting a printing apparatus according to the present disclosure.

FIG. 2 is a block diagram depicting the configuration of the printing apparatus.

FIG. 3A is a diagram of a medium having an inverted image which is a print image and a code of a transfer condition printed thereon is seen from the front side thereof; FIG. 3B is a diagram of the medium as seen from the rear side thereof, and a transfer medium.

FIG. 4A is a diagram depicting the transfer medium on which the medium is placed, and a transfer device; FIG. 4B is a diagram depicting the transfer medium on which an inverted image is transferred, and the medium.

FIG. 5 is a graph indicating a tone curve for a usage amount reducing process.

FIG. 6 is a flow chart indicating an example of a control method of the printing apparatus.

FIG. 7 is a flow chart indicating an example of a control method of the printing apparatus.

FIG. 8 is a flow chart indicating an example of a control method of the printing apparatus.

FIG. 9 is a flow chart indicating an example of a control method of the printing apparatus.

FIG. 10 is a flow chart indicating an example of a control method of the printing apparatus.

FIG. 11 is a diagram depicting a color gamut of an RGB color space of the printing apparatus.

FIG. 12 is a flow chart indicating an example of a control method of the printing apparatus.

FIGS. 13A and 13B depict a flow chart indicating an example of a control method of the printing apparatus.

FIGS. 14A and 14B depict a flow chart indicating an example of a process related to a flag of FIGS. 13A and 13B.

FIG. 15 is a diagram depicting a partial image and blocks thereof.

FIG. 16 is a flow chart indicating an example of a control method of the printing apparatus.

FIGS. 17A and 17B is a flow chart indicating an example of a process related to a flag of FIG. 16.

### DESCRIPTION

In the following, an embodiment related to the present disclosure will be specifically described with reference to the drawings. Note that in the following description, the same reference numerals are affixed to the same or corresponding elements throughout all the drawings, and any overlapping explanation therefor will be omitted.

### First Embodiment

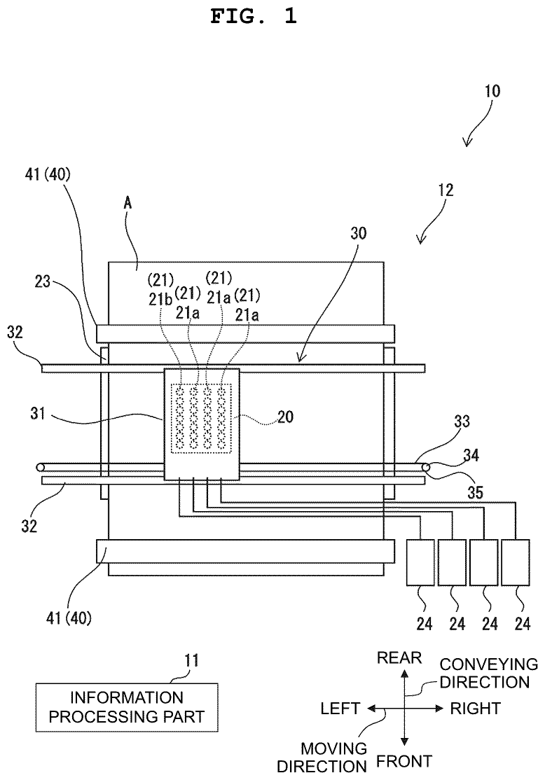

As depicted in FIG. 1, a printing apparatus 10 according to the first embodiment of the present disclosure includes an information processing part 11 and a printer part 12. The information processing part 11 processes image data of a print image, which is an image of an object of a printing process, into a print format printable by the printer part 12. The printer part 12 prints the image on a medium M based on the image data in the print format.

### Printer Part

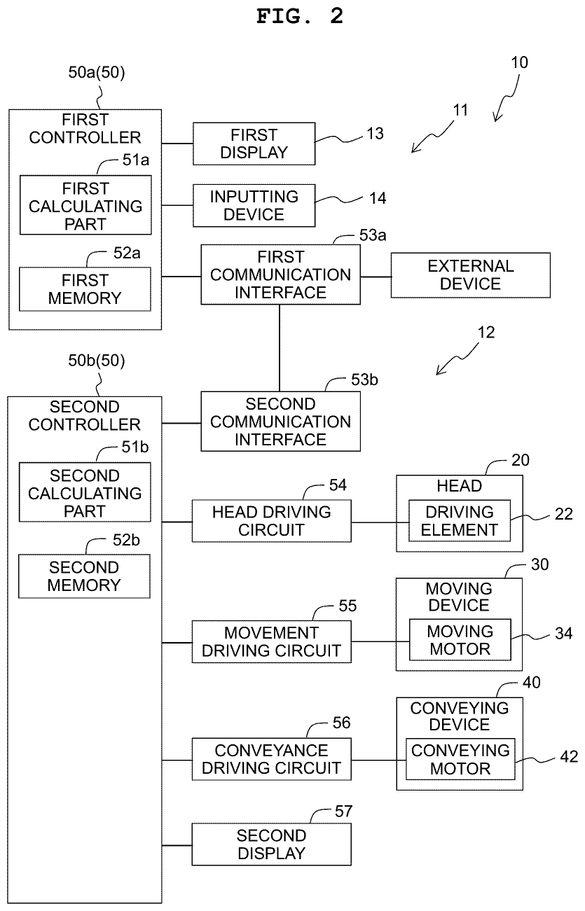

The printer part 12 is a device which is configured to print the image on the medium M based on the image data, and is constructed of a printer such as an ink-jet printer. The printer part 12 includes a head 20. The head 20 has a plurality of nozzles 21 and a plurality of driving elements 22 (see FIG. 2). The plurality of driving elements 22 is piezoelectric elements, heating elements, electrostatic actuators, etc., and each of the plurality of driving elements 22 is provided on one of the plurality of nozzles 21. Each of the plurality of driving elements 22 is driven to thereby apply ejecting energy such as pressure for ejecting an ink from one of the plurality of nozzles 21 to the ink inside the head 20. As a result, the head 20 ejects the ink.

A plurality of nozzle rows is disposed side by side in the left-right direction. Each of the plurality of nozzle rows includes nozzles 21, of the plurality of nozzles 21, which are aligned in the front-rear direction. Each of the plurality of nozzles 21 is open in the lower surface of the head 20. Each of the plurality of nozzle rows ejects one of a plurality of kinds of inks. For example, the plurality of nozzle rows includes a nozzle row of nozzles 21 which eject a cyan ink, a nozzle row of nozzles 21 which eject a magenta ink, a nozzle row of nozzles 21 which ejects a yellow ink, and a nozzle row of nozzles 21 which eject a black ink. These inks are inks each having a sublimating property.

Note that in the following, a moving direction in which the head 20 moves is referred to as the left-right direction. A direction which crosses (for example, which is orthogonal to) the moving direction and in which the medium M is conveyed is referred to as the front-rear direction. Further, a direction which crosses (for example, which is orthogonal to) the moving direction of the head 20 and the conveying direction of the medium M is referred to as the up-down direction. Note, however, that a direction related to the printer part 12 is not limited to these directions.

Further, the printer part 12 includes a platen 23 and a tank 24. The platen 23 is located below the head 20 at a predetermined distance. A flat upper surface of the platen 23 is disposed facing the lower surface of the head 20 and supports the medium M from therebelow. Furthermore, the tank 24 is provided as a plurality of tanks 42 (see FIG. 1) each of which stores one of the plurality of kinds of inks, which communicate with the plurality of nozzles 21 of the head 20, and each of which supplies one of the plurality of kinds of inks to the nozzles 21 of one of the nozzle rows.

Moreover, the printer part 12 includes a moving device 30 which is configured to move the head 20 in the left-right direction. The moving device 30 has a carriage 31, two guide rails 32, an endless belt 33, and a moving motor 34. The carriage 31 is box-shaped and has the head 20 mounted thereon. The two guide rails 32 extend leftward and rightward across the platen 23 which is placed directly below the two guide rails 32, are disposed separately from each other in the front and the rear so as to interpose all the plurality of nozzles 21 therebetween, and movably support the carriage 31. The endless belt 33 is connected to the carriage 31, and is connected to the moving motor 34 via a pulley 35 disposed in the two guide rails 32. Therefore, in the moving device 30, in a case where the moving motor 34 is driven to rotate, the endless belt 33 runs, thereby causing the carriage 31 and the head 20 mounted on the carriage 31 to move in the left-right direction along the two guide rails 32.

Further, the printer part 12 includes a conveying device 40 which is configured to convey the medium M in the front-rear direction. The conveying device 40 has, for example, a conveying roller 41 and a conveying motor 42 (see FIG. 2). The conveying roller 41 has a shaft extending in the left-right direction, and the conveying motor 42 is connected to the shaft of the conveying roller 41. In the conveying device 40, in a case where the conveying motor 42 is driven to rotate, the conveying roller 41 rotates about the shaft thereof, and conveys the medium M in the front-rear direction on the platen 23.

As depicted in FIG. 2, the printer part 12 includes a second controller 50b, a second communication interface 53b electrically connected to the second controller 50b, a second display 57, a head driving circuit 54, a movement driving circuit 55, and a conveyance driving circuit 56. The second display 57 is, for example, a device such as a liquid crystal display which displays information such as a code of a transfer condition, etc. Note that the second controller 50b may be constructed of a single device, or may be constructed of a plurality of devices which is distributed and disposed and which cooperate to perform the operation of the second controller 50b.

The second communication interface 53b is a connecting device which connects to the information processing part 11, and may be connected to the information processing part 11 by wired communication such as a USB cable, etc., or wireless communication such as a LAN, etc. The second controller 50b obtains data such as the image data, etc., from the information processing part 11 via the second communication interface 53b. The image data is data which represents an image to be printed, and which is, for example, raster data. Note that the second communication interface 53b may be connected to another device other than the information processing part 11.

The second controller 50b has a second calculating part 51b and a second memory 52b. The second memory 52b is a memory accessible from the second calculating part 51b and has at least one of, for example, RAM, ROM, E2PROM (E2PROM also known as EEPROM which is a registered trademark of Renesas Electronics Corporation), NVRAM, etc. The second memory 52b stores data input from the second communication interface 53b, as well as a computer program and a variety of kinds of data used for data processing by the second calculating part 51b.

The second calculating part 51b is constructed, for example, of a computer, and includes circuits such as a processor such as a CPU, an integrated circuit such as an ASIC, or both. The second calculating part 51b executes the computer program while referring to stored data in the second memory 52b, and thus the second controller 50b controls the operations of the respective parts of the printer part 12. With this, the printer part 12 executes a variety of kinds of processes such as the printing process of printing an image.

The head driving circuit 54 is electrically connected to the plurality of driving elements 22 of the head 20. The second controller 50b generates, based on the image data, etc., a control signal by which the plurality of driving elements 22 is driven, and the head driving circuit 54 generates, based on the control signal, a drive signal of the plurality of driving elements 22. Further, the plurality of driving elements 22 is driven based on the drive signal so as to impart the ejecting energy to the ink in the head 20 at an ejection timing based on the image data. This causes an ink droplet of the ink to be ejected from each of the plurality of nozzles 21 of the head 20.

The movement driving circuit 55 is electrically connected to the moving motor 34 of the moving device 30. The second controller 50b generates, based on the image data, etc., a control signal by which the moving motor 34 is driven, and the movement driving circuit 55 generates a drive signal of the moving motor 34 based on the control signal. Further, the moving motor 34 is driven based on the drive signal so as to cause the carriage 31 having the head 20 mounted thereon to move in the left-right direction at a variable speed, and so as to stop the carriage 31 at any position within a movable range of the carriage 31.

The conveyance driving circuit 56 is electrically connected to the conveying motor 42 of the conveying device 40. The second controller 50b generates, based on the image data, etc., a control signal by which the conveying motor 42 is driven, and the conveyance driving circuit 56 generates a drive signal of the conveying motor 42 based on the control signal. Further, the conveying motor 42 is driven based on the drive signal so as to convey the medium M on the platen 23 intermittently or continuously in the front-rear direction, and so as to stop the medium M at a predetermined position on the platen 23.

### Information Processing Part

The information processing part 11 is a device configured to process data such as image data of a print image to be printed by the printer part 12, and is constructed of a computer such as a personal computer, a tablet, a smartphone, etc. The information processing part 11 includes: a first controller 50a; and a first communication interface 53a, a first display 13, and an inputting device 14 which are connected to the first controller 50a.

The first controller 50a includes a first calculating part 51a and a first memory 52a. The first memory 52a is a memory accessible from the first calculating part 51a, and includes, for example, RAM and ROM. The RAM temporarily stores the image data, and a variety of kinds of data which are used while the first calculating part 51a performs calculation. The ROM stores a computer program and data for performing a variety of kinds of data processing.

The first calculating part 51a is constructed, for example, of a computer, and includes a circuit such as a processor exemplified by a CPU. The first calculating part 51a executes the computer program while referring to data stored in the first memory 52a, and thus the first controller 50a controls the operation of the information processing part 11. The first controller 50a cooperates with the second controller 50b of the printer part 12 so as to constitute a controller 50 of the printing apparatus 10 and to control the operation of the printing apparatus 10. Note that the first controller 50a may be constructed of a single device, or may be constructed of a plurality of devices which is distributed and disposed to cooperate with each other to perform the operation of the first controller 50a.

The first communication interface 53a is a connecting device which connects to the printer part 12 and an external device which exists independently of the printing apparatus 10; the first communication interface 53a may be connected to the external device via wired communication such as a USB cable, etc., or wireless communication such as a LAN, etc. Examples of the external device include a computer, a portable terminal device, a server, a storage medium, a camera, etc. With this, the first controller 50a transmits and receives the data such as the image data, etc., with respect to the printer part 12 and the external device via the first communication interface 53a.

The first display 13 is, for example, a device such as a liquid crystal display which is configured to display information such as a print mode of a print image, the code of the transfer condition, etc. The inputting device 14 is, for example, a device such as a touch panel, a physical switch, the first communication interface 53a, etc., which is configured to receive input of information from the outside. The inputting device 14 receives an operation by a user and transmits the received operation information to the first controller 50a.

### Conversion Process of Image Data

With respect to the printing process by the printing apparatus 10, the first controller 50a of the information processing part 11 performs a conversion process on the image data of the print image which is the object of the printing process, and transmits the image data converted into a print format to the printer part 12. The conversion process includes, for example, a color conversion process, a half tone process, etc.

In the color conversion process, the first controller 50a uses a predetermined color-conversion look-up table so as to convert the color values of the image data into color values printable by the printer part 12. For example, the color components of the image data are converted from RGB values to CMYK values. The RGB values are the color values of red, green, and blue, respectively, each expressed in 256 gradations from 0 to 255. The CMYK values are color values printable by the ink which can be ejected from the head 20, and are the color values of cyan, magenta, yellow, and black, respectively, each expressed in 101 gradations from 0 to 100.

In the half tone process, the first controller 50a converts the respective color values of the CMYK value of the image data into kinds of dots. These kinds of dots include “no dot” which means no dot is formed, “small dot”, “middle dot” of which size is greater than the small dot, and “large dot” of which size is greater than the middle dot.

### Printing Process

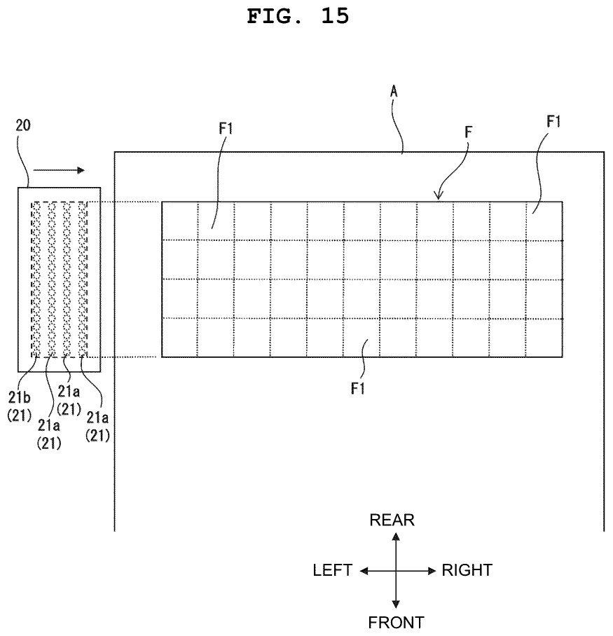

In this manner, the first controller 50a transmits the image data which has been subjected to the conversion process to the second controller 50b. The second controller 50b executes the printing process based on the image data. In the printing process, the second controller 50b executes a pass operation of causing the head 20 to eject the ink from the plurality of nozzles 21 of the head 20 to the medium M while moving the head 20 along the left-right direction based on a partial image data which is a part of the image data. By the pass operation, a partial image F (see FIG. 15) is printed on the medium M. Then, the second controller 50b executes a conveying operation of conveying the medium M along the front-rear direction. By executing the pass operation and the conveying operation, a plurality of partial images F is formed in the front-rear direction, and a print image constructed of the plurality of partial images F is printed on the medium M.

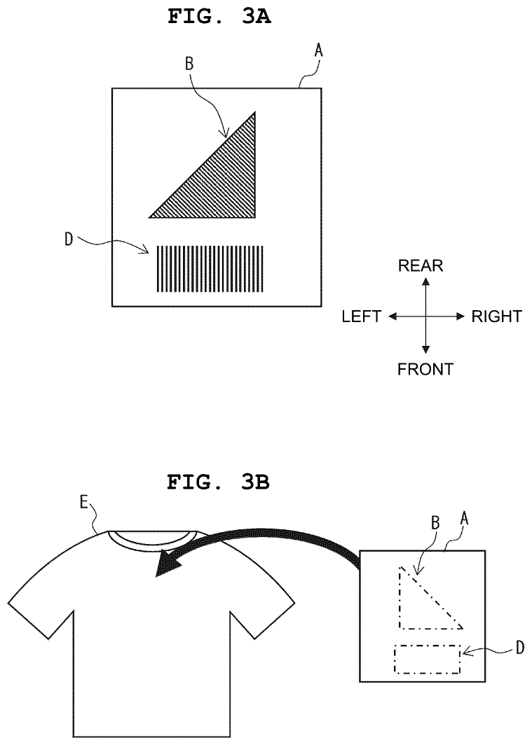

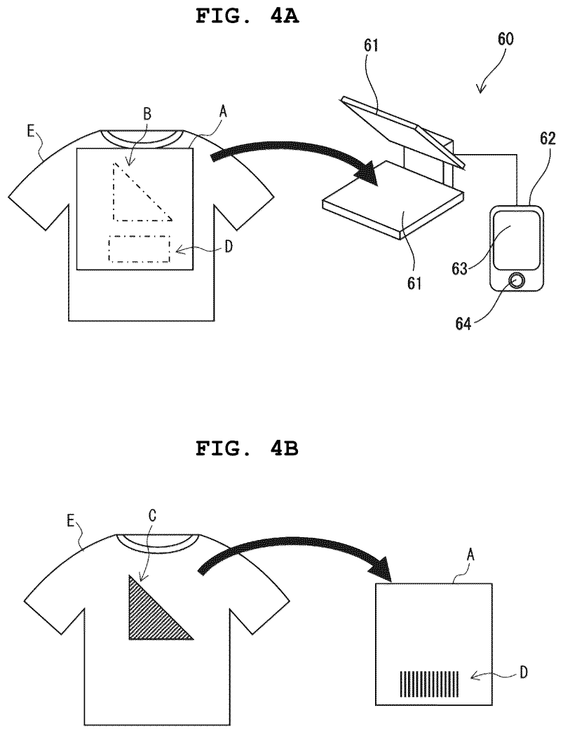

As depicted in FIG. 3A, this print image is an inverted image B which is an image obtained by inverting the front and rear of a transferred image C (FIG. 4B); the transferred image C is an image transferred to a transfer medium E. Note that the medium M on which the print image is to be printed is a sheet having a heat-resisting property, such as a sheet constructed of a fluorine resin, and a sheet constructed of a paper sheet having a fluorine resin coating applied thereto. As the transfer medium E, for example, a cloth such as a T-shirt, etc., and paper are used.

### Transfer Process

In such a manner, the inverted image B is printed on the medium M with the sublimating inks by the printing apparatus 10. Then, the user causes the inverted image B of the medium M to face the transfer medium E, as depicted in FIG. 3B, and places the medium M to be overlaid on the transfer medium E as depicted in FIG. 4A. Then, in a state that at least one of a pair of heating plates 61 of the transfer device 60 is heated, the user sandwiches the transfer medium E on which the medium M is overlaid between the pair of heating plates 61, and heats and presses the medium M. As a result, the sublimating inks of the inverted image B on the medium M are sublimated, and the transferred image C, which is the image obtained by inverting the inverted image B, is transferred to the transfer medium E as depicted in FIG. 4B. Then, the user removes the medium M from the transfer medium E.

### Print Mode and Transfer Condition

As described above, the inverted image B is printed on medium M as the print image by the printing process. The print mode has, for example, a first print mode and a second print mode. The second print mode is a print mode in which an ink usage amount (amount of ink(s) used) to print the inverted image B is smaller than the ink usage amount in the first print mode. In other words, the first print mode is a so-called standard mode, and the second print mode is a so-called ink-saving mode. The ink usage amount for the formation of the inverted image B in the printing process in the second print mode is smaller than the ink usage amount for the formation of the inverted image B of the same size in the printing process in the first print mode. The ink usage amount may be, for example, the amount of the ink(s) forming inverted image B relative to the area of inverted image B.

In a case where the print mode is the second print mode, the first controller 50a executes a usage amount reducing process so that the ink usage amount in the printing process in the second print mode is smaller than the ink usage amount in the first print mode. As a result, the inverted image B is printed using a smaller amount of inks by the printing process in the second print mode than the amount of the inks used in the first print mode. The usage amount reducing process will be described later.

The transfer condition is associated with the print mode in advance and stored in the first memory 52a so as to transfer the inverted image B printed in the second print mode to the transfer medium E and to reduce the decrease in the image quality of the transferred image C. The transfer condition is a condition for transferring the print image printed on the medium M by the printing process to the transfer medium E, and the transfer condition has, for example, a heating temperature, a heating time, and a pressure. The transfer condition includes, for example, a first transfer condition and a second transfer condition. Here, the first transfer condition corresponds to the first print mode, and the second transfer condition corresponds to the second print mode.

In the second transfer condition, a transfer energy for transferring the print image from the medium M to the transfer medium E is greater than the transfer energy in the first transfer condition. The transfer energy is applied to the inverted image B on the medium M in a case where the medium M and the transfer medium E are heated and pressurized between the pair of heating plates 61, as depicted in FIG. 4A. For example, the transfer energy is determined by the heating time, heating temperature, and pressurization pressure. The transfer energy is greater the longer the pressurizing time, the higher the heating temperature, and the higher the pressurization pressure. At least one of the heating time, heating temperature, and pressurization pressure of the second transfer condition is different from the heating time, heating temperature, and pressurization pressure of the first transfer condition, thereby making the transfer energy in the second transfer condition greater than the transfer energy in the first transfer condition.

In the second print mode, the ink usage amount forming the inverted image B is smaller than the ink usage amount forming the inverted image B in the first print mode. Even in such a case, by using the second transfer condition with the greater transfer energy as the transfer condition for the inverted image B, the small amount of the ink(s) forming the inverted image B in a case where the inverted image B is transferred from the medium M to the transfer medium E is compensated more than in the first transfer condition. Therefore, the decrease in the image quality of the transferred image C to which the inverted image B has been transferred can be reduced.

### Usage Amount Reducing Process

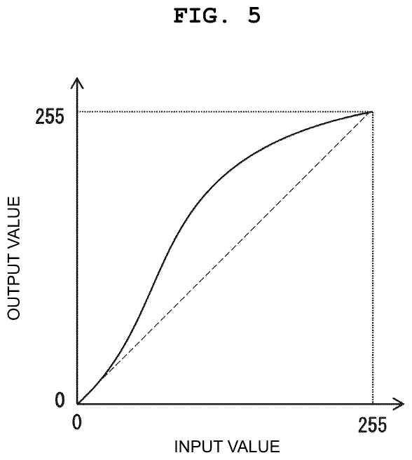

The usage amount reducing process is performed using, for example, a tone curve so that the ink usage amount in the second print mode is smaller than the ink usage amount in the first print mode. As depicted in FIG. 5, the tone curve defines the corresponding relationship between an input value and an output value, which take on an RGB value of 0 to 255, and is stored in advance in the first memory 52a. A tone curve depicted by the broken line in FIG. 5 has the output value which is the same as the input value, and the ink usage amount is not reduced.

In contrast, a tone curve depicted by the solid line in FIG. 5 has output values which are the same as or greater than the input values, and among these output values, the output values which are greater than the input values are numerous than the output values which are the same as the input values. Using this tone curve, the usage amount reducing process is performed with the RGB value of each of the pixels in the image data as the input value. With this, the RGB value of each of the pixels in the image data has the output value of the tone curve and is equal to or greater than the input value. As a result, the density of the print image which has been subjected to the usage amount reducing process is lowered overall, and the ink usage amount of the print image is reduced.

Note that the usage amount reducing process is not limited to the method using the tone curve. For example, the first controller 50a may execute a half tone process on the image data so that the dot size of the image data for the second print mode is smaller than the dot size in the first print mode. Further, the first controller 50a may execute, with respect to the image data, a half tone process similar to the half tone process performed for the first print mode, and then may execute a correcting process on the image data so as to reduce the dot size or the number of dots. By executing the printing process based on such image data for the second print mode, the ink usage amount of the print image is reduced.

### Transfer Device

As depicted in FIG. 4A, the transfer device 60 includes the pair of heating plates 61 and a controller 62. As described above, the pair of heating plates 61 sandwiches the medium M, on which the inverted image B is printed, and the transfer medium E between the pair of plates 61, and applies heat and pressure to the inverted image B so as to transfer the inverted image B from the medium M to the transfer medium E.

The controller 62 is constructed of a computer such as a portable terminal device and a personal computer, etc., is capable of performing communication via a communication interface, such as wireless or wired communication interface, and includes inputting devices such as a touch panel 63, a camera 64, etc. Further, the controller 62 includes a calculating part constructed of a processor such as a CPU, etc., and a memory constructed of a memory such as RAM, ROM, etc. The calculating part executes a program stored in the memory, whereby the controller 62 controls the operation of the transfer device 60.

### First Outputting Process

The printing apparatus 10 executes a first outputting process of outputting the first transfer condition or the second transfer condition as the transfer condition for transferring the print image. In a case where the printing apparatus 10 outputs the transfer condition corresponding to the print mode for printing the inverted image B, which is the print image, the controller 62 of the transfer device 60 obtains the transfer condition. For example, the printing apparatus 10 prints (outputs) a code D of the transfer condition on (to) the medium M together with inverted image B. In response to this, the transfer device 60 reads the code D printed on the medium M with the camera 64, and the controller 62 obtains the transfer condition corresponding to the code D and controls the transfer device 60 in accordance with the transfer condition.

The code D is obtained by encoding the first transfer condition and the second transfer condition, each as the transfer condition, in accordance with a predetermined rule, and image data of the code D is stored in the first memory 52a. As the code D, for example, a two-dimensional code such as a matrix code, etc., or a one-dimensional code such as a barcode, etc., is used. Note that the code D may be printed with a predetermined amount of the ink, regardless of the print mode in which inverted image B is printed.

Note that the output of the transfer condition is not limited to the printing of the code D. For example, the printing apparatus 10 may display (output) the code D of the transfer condition corresponding to the print mode, on (to) at least one of the first display 13 and the second display 57. In this case, the transfer device 60 may read the code D with the camera 64, and the controller 62 may obtain the transfer condition corresponding to the code D.

Further, the printing apparatus 10 may transmit (output) the transfer condition corresponding to the print mode via the first communication interface 53a. In this case, the transfer device 60 may receive the transfer condition via the communication interface, and the controller 62 may obtain the transfer condition from the communication interface.

Furthermore, the printing apparatus 10 may display (output) the transfer condition corresponding to the print mode on (to) at least one of the first display 13 and the second display 57. Moreover, the printing apparatus 10 may print (output) the transfer condition corresponding to the print mode on (to) the medium M. The transfer condition includes at least one of the heating temperature, the heating time, and the pressure. In this case, the user may view the transfer condition and input the transfer condition to the controller 62 via the inputting device 14 such as the touch panel 63, etc., of the transfer device 60.

In this manner, the transfer device 60 is controlled by the controller 62 in accordance with the transfer condition. With this, the inverted image B is heated and pressurized by the pair of heating plates 61 at the pressure, heating temperature, and heating time in accordance with the transfer condition, and is transferred to the transfer medium E.

In contrast, the code D of the transfer condition is not transferred to the transfer medium E. For example, the code D may not be transferred by not being heated and pressurized by the pair of heating plates 61. Further, the code D may not be transferred by being printed with an ink which is not transferred even in a case where the ink is heated and pressurized. Furthermore, the code D may not be transferred by being printed on the rear side of medium M which is opposite to the front side having the inverted image B printed thereon.

### Control Method of Printing Apparatus

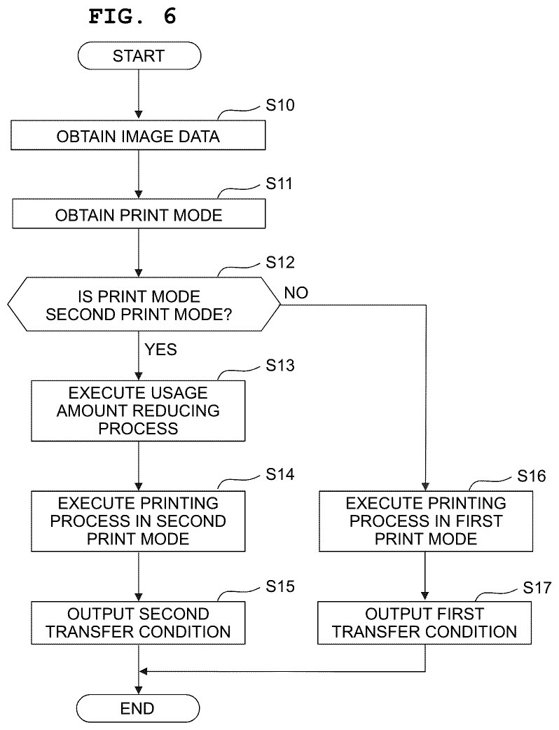

The printing apparatus 10 is controlled by the first controller 50a and the second controller 50b as the controller 50 and, for example, according to the flow chart of FIG. 6. For example, the printing apparatus 10 starts the process of FIG. 6 in response to a start instruction from a user using the inputting device 14. In the process of FIG. 6, the first controller 50a obtains image data of the inverted image B, which is the object of the printing process, from the first communication interface 53a, the first memory 52a, etc. (step S10).

Further, the first controller 51a obtains the print mode in a case where the inverted image B is to be printed (step S11). For example, the first controller 50a displays the first print mode and the second print mode, as options of the print mode, on the first display 13. In response to this, in a case where the user uses the inputting device 14 so as to select the first print mode or the second print mode as the print mode of the inverted image B, the selected print mode is input to the first controller 50a by the inputting device 14. With this, the first controller 50a obtains the print mode from the inputting device 14.

Then, the first controller 50a executes a first determining process so as to determine whether or not the print mode is the second print mode (step S12). In a case where the first controller 50a determines that the print mode is the second print mode in the first determining process (step S12: YES), the first controller 50a executes the usage amount reducing process. In the usage amount reducing process, the first controller 50a generates image data for the second print mode, from the image data obtained in step S10, so that the ink usage amount is smaller than the ink usage amount in the first print mode (step S13). Then, the first controller 50a executes the conversion process on the image data so as to generate the image data in the print format and transmits the image data to the second controller 50b.

The second controller 50b executes the printing process based on the image data for the second print mode (step S14). The inverted image B is printed by the printing process in the second print mode, and the ink usage amount used for the inverted image B is smaller than the ink usage amount in the printing in the first print mode.

Further, the first controller 50a executes the first outputting process and outputs the second transfer condition corresponding to the second print mode as the transfer condition (step S15). Here, the first controller 50a transmits the image data of the code D of the second transfer condition to the second controller 50b, and the second controller 50b prints (outputs) the code D on (to) the medium M based on the image data.

In such a manner, the inverted image B and the code D of the second transfer condition are printed on the medium M. The user reads the code D with the camera 64 of the transfer device 60, and thus the code D is input to the controller 62. The controller 62 controls the transfer device 60 in accordance with the second transfer condition corresponding to the code D. Then, the user places the medium M and the transfer medium E between the pair of heating plates 61. With this, the medium M and the transfer medium E are heated and pressurized by the pair of heating plates 61 in accordance with the heating temperature, the heating time, and the pressure of the second transfer condition, and the inverted image B on the medium M is transferred to the transfer medium E. The transfer energy in the second transfer condition is greater than the transfer energy in the first transfer condition. Therefore, even regarding the inverted image B of the second print mode having a smaller amount of the inks than the amount of the inks in the first print mode, the small amount of the inks due to the transfer is compensated, and the decrease in the image quality of the transferred image C transferred to the transfer medium E can be reduced.

Further, in a case where the first controller 50a determines that the print mode is the first print mode in the first determining process of step S12 (step S12: NO), the first controller 50a does not execute the usage amount reducing process and generates the image data obtained in step S10 as the image data for the first print mode. Then, the first controller 50a executes the conversion process on the image data and transmits the image data for the first print mode in the print format to the second controller 50b. The second controller 50b executes the printing process in the first print mode based on the image data (step S16). The ink usage amount used in the printing of the inverted image B printed by the printing process is greater than the ink usage amount used in the printing in the second print mode.

Furthermore, the first controller 50a executes the first outputting process and outputs the first transfer condition corresponding to the first print mode as the transfer condition (step S17). Here, the first controller 50a transmits the image data of the code D of the first transfer condition to the second controller 50b, and the second controller 50b prints (outputs) the code D on (to) the medium M based on the image data.

In such a manner, the inverted image B and the code D of the first transfer condition are printed on the medium M. The user reads the code D with the camera 64 of the transfer device 60, and thus the code D is input to the controller 62. The controller 62 controls the transfer device 60 in accordance with the first transfer condition corresponding to the code D. Then, the user places the medium M and the transfer medium E between the pair of heating plates 61. With this, the medium M and the transfer medium E are heated and pressurized by the pair of heating plates 61 in accordance with the heating temperature, the heating time, and the pressure of the first transfer condition, and thus the inverted image B on the medium M is transferred to the transfer medium E. The small transfer energy can reduce the transfer cost.

### First Modification

In a printing apparatus 10 according to the first modification, in the first embodiment, the controller 50 executes a property determining process of determining whether or not the transfer medium E has a heat-resisting property. Further, in a case where the first controller 50a determines that the transfer medium E does not have the heat-resisting property in the property determining process, the controller 50 outputs the first transfer condition as the transfer condition in the first outputting process.

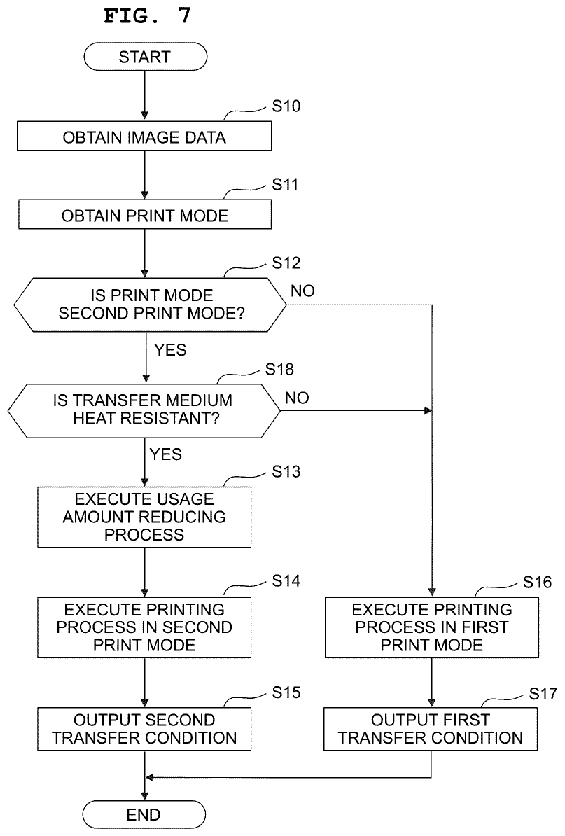

Specifically, the printing apparatus 10 according to the first modification is controlled by the first controller 50a and the second controller 50b, as the controller 50, in accordance with a flow chart depicted in an example of FIG. 7. In FIG. 7, in addition to steps S10 to S17 in FIG. 6, the property determining process of step S18 is executed between steps S12 and S13.

That is, the first controller 50a obtains the image data and the print mode of the inverted image B (steps S10 and S11). Then, in a case where the first controller 50a determines that the print mode is the second print mode (step S12: YES), the first controller 50a executes the property determining process and determines whether or not the transfer medium E has the heat-resisting property (step S18).

For example, the first controller 50a displays options of the material of the transfer medium E on the first display 13. Examples of the material include cotton, linen, polyester, rayon, etc. Regarding this, in a case where the user uses the inputting device 14 so as to select, from the options, the material of the transfer medium E to which the inverted image B is to be transferred, the selected material is input to the first controller 50a by the inputting device 14. The association between the material and the presence or absence of the heat-resisting property is stored in advance in the first memory 52a. Therefore, the first controller 50a determines the presence or absence of the heat-resisting property of the transfer medium E based on the heat-resisting property corresponding to the material.

Here, in a case where the first controller 50a determines that the transfer medium E has the heat-resisting property (step S18: YES), the first controller 50a executes the usage amount reducing process (step S13), and the second controller 50b executes the printing process in the second print mode (step S14). Further, the first controller 50a executes the first outputting process and transmits the second transfer condition corresponding to the second print mode to the second controller 50b, and the second controller 50b prints (outputs) the code D of the second transfer condition on (to) the medium M in the first outputting process (step S15). With this, since the transfer medium E having the heat-resisting property is not easily deteriorated by the transfer, the small amount of the ink forming the inverted image B due to the transfer is compensated by increasing the transfer energy of the transfer in the second transfer condition, and the decrease in the image quality of the transferred image C transferred to the transfer medium E can be reduced.

In a case where the first controller 50a determines that the print mode is the first print mode in step S12 (step S12: NO) and in a case where the first controller 50a determines that the transfer medium E does not have the heat-resisting property in step S18 (step S18: NO), the first controller 50a executes the printing process in the first print mode (step S16). Further, the first controller 50a executes the first outputting process and transmits the first transfer condition corresponding to the first print mode to the second controller 50b, and the second controller 50b prints (outputs) the code D of the first transfer condition on (to) the medium M in the first outputting process (step S17). In such a manner, since the transfer medium E which does not have the heat-resisting property is easily deteriorated by the transfer, the transfer energy of the first transfer condition is reduced to thereby reduce the decrease in the image quality of the transferred image C due to the deterioration of the transfer medium E. Furthermore, the small transfer energy can reduce the transfer cost.

### Second Modification

In a printing apparatus 10 according to the second modification, in the first

embodiment and the first modification, the print mode of the printing process includes a third print mode which is different from the first print mode and the second print mode and is for forming a print image of fine lines. The transfer condition includes a third transfer condition in which the transfer energy is smaller than the transfer energy in the first transfer condition. The controller 50 executes a second determining process of determining whether or not the print mode is the third print mode, and a second outputting process of outputting the third transfer condition as the transfer condition in a case where the first controller 50a determines that the print mode is the third print mode in the second determining process.

Specifically, the print mode includes the third print mode in addition to the first and second print modes. The third print mode is a print mode which is more suitable for printing fine lines than the first and second print modes. The fine line is, for example, a line image in which the width of the line in a direction orthogonal to a direction in which the line extends is a predetermined value or less, or a line image in which the dimension of the line in the direction orthogonal to the direction in which the line extends is a predetermined value or less with respect to the dimension of the line in the direction in which the line extends.

Note that, in the third print mode, the ink usage amount used in the printing of the inverted image B, which is a print image of fine lines, may be smaller than the ink usage amount in the second print mode. In this case, the first controller 50a may execute the usage amount reducing process so that the ink usage amount in the printing process in the third print mode is smaller than the ink usage amount in the second print mode.

The third print mode is associated in advance with the third transfer condition and stored in the first memory 52a. The third transfer condition is a transfer condition in which the transfer energy for transferring the print image from the medium M to the transfer medium E is smaller than the transfer energy in the first transfer condition. At least one of the heating time, the heating temperature, and the pressurization pressure of the third transfer condition is different from the heating time, heating temperature, and pressurization pressure of the first transfer condition, and thus the transfer energy of the third transfer condition is smaller than the transfer energy of the first transfer condition. For this reason, the transfer energy decreases in the order of the second print mode, the first print mode, and the third print mode.

In accordance with the third transfer condition, the transfer energy smaller than the transfer energy in the first transfer condition is applied to the inverted image B of the fine lines printed in the third print mode. With this, in a case where the transfer is performed under the third transfer condition, the amount of the ink of the inverted image B transferred from medium M to the transfer medium E is kept smaller than the amount of the ink under the first transfer condition. With this, the lines are less likely to be thicker due to the transfer, and thus the decrease in the image quality due to thickening of the lines can be reduced.

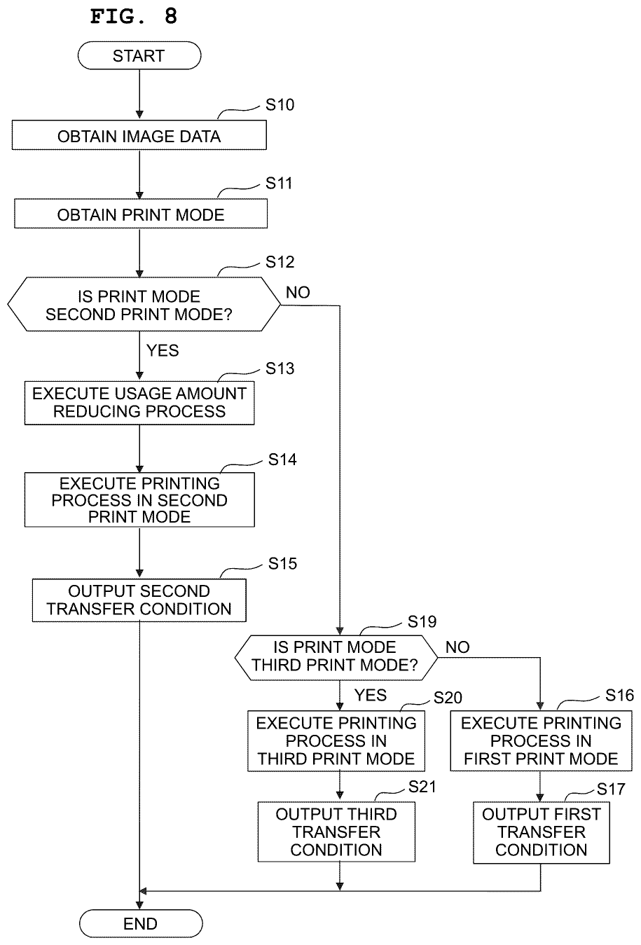

The printing apparatus 10 according to the second modification is controlled by the first controller 50a and the second controller 50b as the controller 50, in accordance with a flow chart depicted in an example of FIG. 8. In FIG. 8, in addition to the processes of steps S10 to S17 in FIG. 6, the second determining process and the second outputting process of steps S19 to S21 are executed after step S12: NO.

That is, the first controller 50a obtains the image data of the inverted image B and the print mode thereof (steps S10 and S11). Then, in a case where the first controller 50a determines that the print mode is the second print mode (step S12: YES), the first controller 50a executes the usage amount reducing process (step S13). The second controller 50b executes the printing process in the second print mode (step S14) and prints (outputs) the code D of the second transfer condition (step S15).

Further, in a case where the first controller 50a determines that the print mode is not the second print mode in step S12 (step S12: NO), the first controller 50a executes the second determining process and determines whether or not the print mode is the third print mode (step S19). In a case where the first controller 50a determines that the print mode is the first print mode in the second determining process of step S19 (step S19: NO), the first controller 50a executes the printing process in the first print mode (step S16). Furthermore, the first controller 50a executes the first outputting process and transmits the first transfer condition corresponding to the first print mode to the second controller 50b, and the second controller 50b prints (outputs) the code D of the first transfer condition on (to) the medium M (step S17). Since the transfer energy in the first transfer condition is small, a reduction in the transfer cost can be achieved.

In a case where the first controller 50a determines that the print mode is the third print mode in the second determining process of step S19 (step S19: YES), the first controller 50a executes the usage amount reducing process on the image data obtained in step S10. The usage amount reducing process reduces the ink usage amount in the third print mode to an extent greater than the ink usage amount in the second print mode. Further, the first controller 50a executes the conversion process on the image data, generates the image data in the print format, and transmits the image data to the second controller 50b. The second controller 50b executes the printing process in the third print mode based on the image data (step S20). As a result, the ink usage amount in the printing of the inverted image B of the fine lines is smaller than in the ink usage amount in the printing in the second print mode.

Furthermore, the first controller 50a executes the second outputting process and transmits the image data of the code D of the third transfer condition corresponding to the third print mode to the second controller 50b. The second controller 50b prints (outputs) the code D on (to) the medium M based on the image data (step S21).

By reading the code D of this third transfer condition with the camera 64 of the transfer device 60, the third transfer condition is input to the controller 62, and the transfer device 60 is controlled by the controller 62 in accordance with the third transfer condition. With this, the medium M and the transfer medium E are heated and pressurized by the pair of heating plates 61 of the transfer device 60, and the inverted image B on the medium M is transferred to the transfer medium E. In accordance with the third transfer condition, the transfer energy smaller than the transfer energy in the first transfer condition is applied to the inverted image B of the fine lines. With this, the amount of the ink of the transferred inverted image B is kept smaller than the amount of the ink in the first transfer condition, and thus the decrease in the image quality due to thickening of the lines can be reduced.

### Second Embodiment

In a printing apparatus 10 according to the second embodiment, in the first embodiment and the first and second modifications, in a case where the first controller 50a determines that the print mode is the second print mode in the first determining process, the controller 50 executes a bidirectional printing process in which the ink(s) is (are) ejected from the head 20 in a forward route and a return route of the moving direction. In a case where the first controller 50a determines that the print mode is not the second print mode in the first determining process, the controller 50 executes a unidirectional printing process in which the ink(s) is (are) ejected from the head 20 in the forward route or the return route of the moving direction.

Specifically, in the bidirectional printing process, the pass operation of ejecting the ink while moving the head 20, and the conveying operation of conveying the medium M are executed alternately. Therefore, a plurality of pass operations in the bidirectional printing process alternate between a pass operation in the forward route of ejecting the inks from the head 20 in the forward route in which head 20 moves toward one side in the left-right direction and a pass operation in the return route of ejecting the inks from the head 20 in the return route in which head 20 moves toward the other side in the left-right direction.

Thus, in the bidirectional printing process, the moving direction of head 20 in the left-right direction is different between the pass operation in the forward route and the pass operation in the return route. With respect to this, the nozzle rows are disposed side by side in the left-right direction, and the cyan ink, the magenta ink, the yellow ink, and the black ink are ejected, respectively, from the nozzles 21 of the nozzle rows according to the order by which the nozzle rows are disposed side by side in the left-right direction. With this, an overlaying order by which the inks ejected from nozzles 21 of the respective nozzle rows are overlaid is different between the pass operation in the forward route and the pass operation in the return route. For this reason, even in a case where the kinds and the amounts of the overlaid inks are the same in the pass operation in the forward route and the pass operation in the return route, a color difference might occur between the pass operation in the forward route and the pass operation in the return route, in some cases. In the following, this color difference will be referred to as “color difference between directions”.

In contrast to the foregoing, in the unidirectional printing process, in addition to the pass operation in which the head 20 moves and ejects the inks while moving the head 20 and the conveying operation of conveying the medium M, a moving operation of moving the head 20 without ejecting the inks is executed. In the plurality of pass operations in the unidirectional printing process, pass operations in each of which the inks are ejected from the head 20 in the forward route in which the head 20 is moved toward the one side in the left-right direction are executed continuously. Therefore, in the return route, in which the head 20 moves toward the other side in the left-right direction, the moving operation is executed without ejecting the inks from the head 20.

In such a manner, in the unidirectional printing process, the moving direction of the head 20 in the left-right direction is the same in the plurality of pass operations. Therefore, the overlaying order of the inks ejected from the nozzles 21 of the respective nozzle rows is the same in the plurality of pass operations, and thus no color difference between directions occurs in the partial image F formed by the pass operations.

Further, in the second print mode, the ink usage amount with which the partial image F is formed by the pass operation is smaller than the ink usage amount in the first print mode. Therefore, the color difference between directions between the pass operation in the forward route and the pass operation in the return route is less likely to occur in the second print mode than in the first print mode. Therefore, the bidirectional printing process is executed in the second print mode, and the unidirectional printing process is executed in the first print mode.

### Control Method of Printing Apparatus

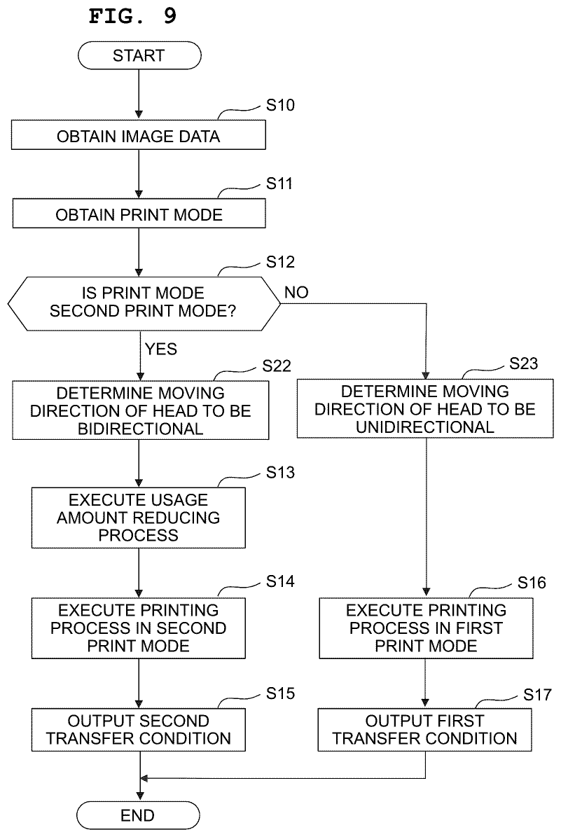

A printing apparatus 10 according to the second embodiment is controlled by the first controller 50a and the second controller 50b, as the controller 50, in accordance with a flow chart depicted in an example of FIG. 9. In the flow chart of FIG. 9, in addition to the processes of steps S10 to S17 in FIG. 6, a process of step S22 between step S12 and step S14 and a process of step S23 between step S12 and step S16 are executed.

That is, the first controller 50a obtains the image data of the inverted image B and the print mode of the printing process therefor (steps S10 and S11). In a case where the first controller 50a determines that the print mode is the second print mode (step S12: YES), the first controller 50a determines the moving direction of the head 20 in the plurality of pass operations in the printing process to be bidirectional, that is, the bidirectional moving direction which is both leftward and rightward (step S22) and executes the usage amount reducing process (step S13), and the second controller 50b executes the bidirectional printing process in the second print mode (step S14).

The bidirectional printing process allows the head 20 to eject the inks while moving in both directions of leftward and rightward, thereby accelerating the printing process. Further, since the amounts of inks forming the printed inverted image B are small, the color of the image printed in the second print mode is lighter than the color in the first print mode. Therefore, the color difference between directions between partial images F formed, respectively, by the plurality of pass operations is reduced, and thus the decrease in the image quality due to the color difference between directions is reduced.

Furthermore, the first controller 50a outputs the second transfer condition corresponding to the second print mode, as the transfer condition (step S15). In accordance with this second transfer condition, the transfer device 60 transfers the inverted image B from the medium M to the transfer medium E. Since the color difference between directions in the inverted image B is reduced, the decrease in the image quality due to the color difference between directions can be reduced also in the transferred image C to which the inverted image B is transferred.

In a case where the first controller 50a determines that the print mode is the first print mode in step S12 (step S12: NO), the first controller 50a determines the moving direction of the head 20 in the plurality of pass operations in the printing process to be unidirectional, that is, the unidirectional moving direction which is toward one of leftward and rightward (step S23), and the second controller 50b executes the unidirectional printing process in the first print mode (step S16). The moving direction in this pass operation is a predetermined direction, and, for example, the inks are ejected in the forward route and the inks are not ejected in the return route. With this, the manner by which the plurality of kinds of inks is overlaid is the same in the plurality of pass operations, and thus no color difference between directions occurs between the partial images F formed, respectively, by the plurality of pass operations.

Further, the first controller 50a outputs the first transfer condition corresponding to the first print mode as the transfer condition (S17). In accordance with the first transfer condition, the transfer device 60 transfers the inverted image B from the medium M to the transfer medium E. Since no color difference between directions occurs in this inverted image B, the decrease in the image quality due to the color difference between directions can be reduced also in the transferred image C to which the inverted image B is transferred.

### Third Modification

Note that in the second embodiment as described above, all the partial images F in the print image are formed by the pass operation in the forward route by the unidirectional printing process in the first print mode. However, a partial image F in which the color difference between directions is small may be formed by the pass operation in the return route. For this reason, in the third modification, in a case where the first controller 50a determines that the print mode is not the second print mode in the first determining process, the controller 50 executes a direction determining process of determining whether to cause the head 20 to eject the inks in the forward route or the return route of the moving direction, based on the color difference between an image in which the inks are ejected from the head 20 in the forward route of the moving direction and an image in which the inks are ejected from the head 20 in the return route of the moving direction.

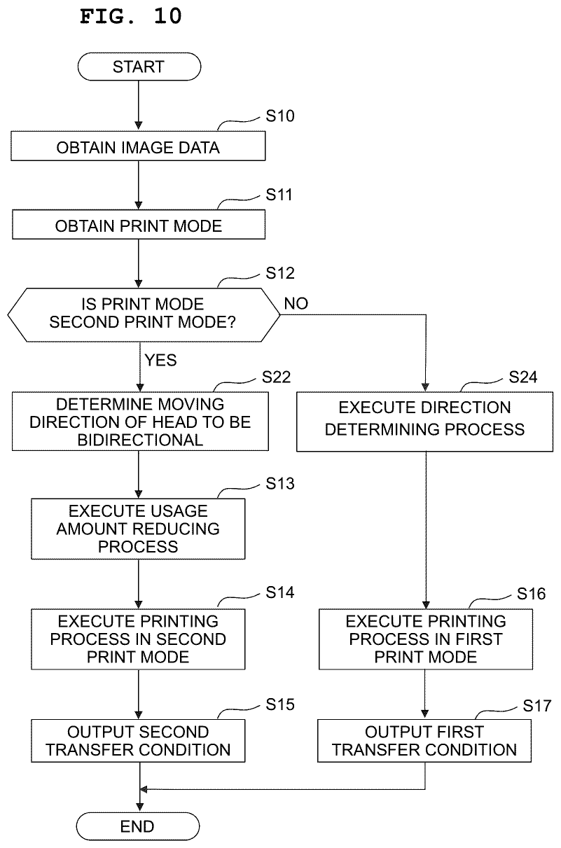

A printing apparatus 10 according to the third modification is controlled by the first controller 50a and the second controller 50b as the controller 50 in accordance with a flow chart depicted in an example of FIG. 10. In FIG. 10, instead of step S23 in FIG. 9, the direction determining process of step S24 is executed. In the direction determining process, the first controller 50a obtains a color value of each of a plurality of pixels in a partial image data as an object of the pass operation. Examples of this color value include an RGB value and a CMYK value, etc.

Further, the first controller 50a obtains an index value from the color value of the pixel based on an index table. The index table is a table which associates a color value with an index value of the color value, and is stored in advance in the first memory 52a. The index value is the extent of the color difference between directions of the color value, and represents the difference in colors between the image of the color value formed by the pass operation in the forward route and the image of the color value formed by the pass operation in the return route.

Further, the first controller 50a obtains index values of a plurality of pixels constructing the partial image F based on the partial image data, and calculates an average value of the plurality of index values as an evaluation value of the partial image F. This evaluation value is the extent of the color difference between directions of the partial image F, and represents the difference in colors between the case where the partial image F is formed by the pass operation in the forward route and the case where the partial image F is formed by the pass operation in the return route.

Furthermore, in a case where the first controller 50a determines that the evaluation value of partial image F is a predetermined value or more, the color difference between directions of the partial image F is great. In this case, the partial image F is formed by the pass operation in the forward route which is the predetermined direction. On the other hand, in a case where the first controller 50a determines that the evaluation value of partial image F is less than the predetermined value, the color difference between directions of the partial image F is small. In this case, even in a case where this partial image F is formed by the pass operation in the return route, which is the opposite of the predetermined direction, the color difference between directions is less conspicuous. Therefore, this partial image F is formed by the pass operation in the return route.

In such a manner, in the printing process of the first print mode, the plurality of partial images F which construct the print image is basically formed by the pass operations in the predetermined direction (e.g., the forward route). However, with respect to a partial image F in which the color difference between directions is small, even in a case where the partial image F in which the color difference between directions is small is formed by a pass operation in the opposite direction to the predetermined direction (e.g., the return route), the difference in colors as compared with another partial image F formed by the pass operation in the forward route is less conspicuous. For this reason, the partial image F in which the color difference between directions is small is formed by the pass operation in the return route. Since the pass operation in the return route is executed instead of the moving operation of the head 20, the printing process can be accelerated while reducing the decrease in the image quality due to the color difference between directions.

### Third Embodiment

In a printing apparatus 10 according to the third embodiment, in the first and second embodiments and the first to third modifications, the head 20 has first nozzles 21a from each of which one of a plurality of kinds of color inks including two or more kinds of color inks capable of expressing black by being mixed is ejected, and a second nozzle 21b from which a black ink is ejected. The controller 50 executes a pixel obtaining process of obtaining, based on the image data, a dark pixel which has a color value closer to black than a first color value, from among pixels of a print image. In a case where the first controller 50a determines that the print mode is the second print mode in the first determining process, the controller 50 executes a color substituting process of using the black ink rather than mixing the plurality of kinds of color inks in the formation of the dark pixel in the printing process.

Specifically, as depicted in FIG. 1, the plurality of nozzles 21 includes first nozzles 21a and second nozzles 21b. The second nozzles 21b eject the black ink. The first nozzles 21a eject a color ink; the color ink includes, for example, a cyan ink, a magenta ink, and a yellow ink. In a case where the same amounts, respectively, of the cyan ink, magenta ink, and yellow ink overlap, these inks are mixed so as to express the black. For this reason, in the color substituting process, black of a single color composed of the black ink is used for a dark pixel containing black as a color component thereof, instead of black of a mixed color expressed by the cyan ink, the magenta ink, and the yellow ink.

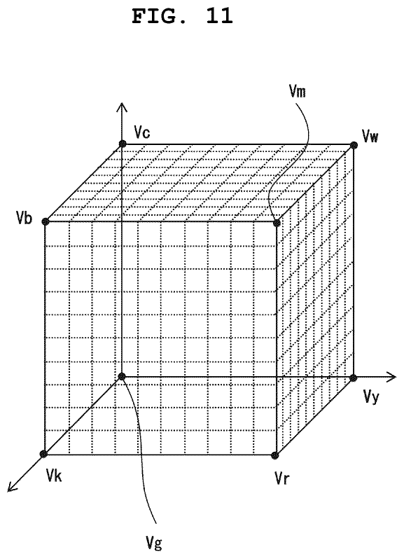

As depicted in FIG. 11, the color gamut of an RGB color space of the printing apparatus 10 is expressed by a three-dimensional orthogonal coordinate system and has a cuboid shape. The color gamut has eight apexes. The eight apexes have black apex Vk (0,0,0), red apex Vr (255,0,0), green apex Vg (0,255,0), blue apex Vb (0,0,255), cyan apex Vc (0,255,255), magenta apex Vm (255,0,255), yellow apex Vy (255,255,0), and white apex Vw (255,255,255). In the color gamut, colors are each expressed by color values of (red R, green G, blue B). The black apex Vk (0,0,0) represents black, and the white apex Vw (255,255,255) represents white.

Each of the plurality of pixels in the image data is represented by a color value in the color gamut of the RGB color space. In the color gamut, the closer the color value of a pixel is to black apex Vk, the darker the color of the pixel is expressed, and in a case where the color value of the pixel is equal to the black apex Vk, the color of the pixel expresses the darkest black. Further, in the color gamut of the RGB color space, the closer the color value of a pixel is to white apex Vw, the brighter the color of the pixel is expressed, and in a case where the color value of a pixel is equal to the white apex Vw, the color of the pixel expresses the brightest white.

In such a color gamut of the RGB color space, the first controller 50a determines that a pixel is a dark pixel in a case where the color value of the pixel is closer to the black apex Vk than the first color value. For example, in the color gamut of the RGB color space, in a case where the shortest distance between the color value of the pixel and the black apex Vk is less than the shortest distance between the first color value and the black apex Vk, the color value of the pixel is closer to the black apex Vk than the first color value, and the first controller 50a determines that the pixel is a dark pixel. Further, in the color gamut of the RGB color space, in a case where the shortest distance between the color value of the pixel and the white apex Vw is less than the shortest distance between the second color value and the white apex Vw, the color value of the pixel is closer to the white apex Vw than the second color value, and the first controller 50a determines that the pixel is a bright pixel. Note that the second color value may be the same as the first color value, or may be different from the first color value.

Furthermore, in the color-conversion look-up table used in the color conversion process of the image data, the RGB values, which are color values in the color gamut of the RGB color space, are associated with the CMYK values. For example, the RGB value (0,0,0) of the black apex Vk is associated with a CMYK value (0,0,0,100), and the RGB value (255,255,255) of the white apex Vw is associated with a CMYK value (0,0,0,0). Moreover, the closer the color of the pixel is to the black apex Vk, the greater the K value of the CMYK value becomes.

### Control Method of Printing Apparatus

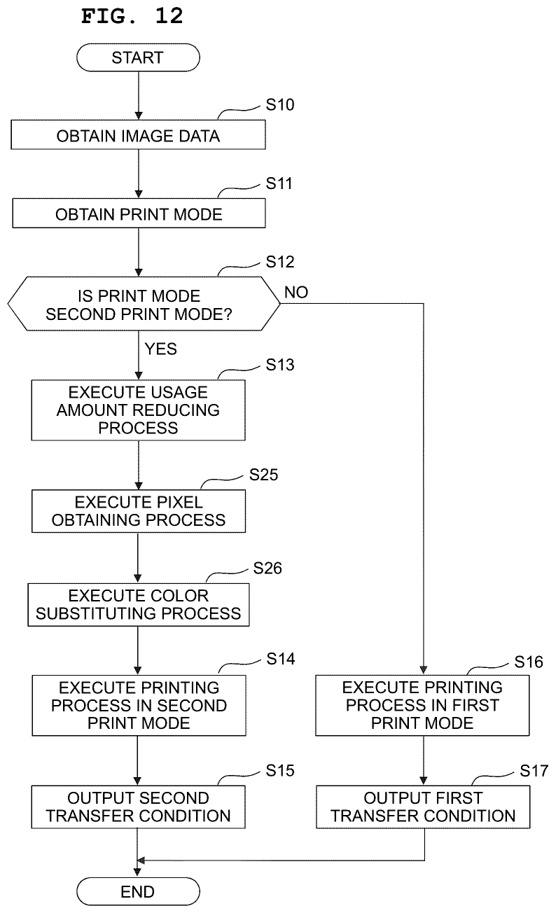

A printing apparatus 10 according to the third embodiment is controlled by the first controller 50a and the second controller 50b, as the controller 50, in accordance with a flow chart depicted in an example of FIG. 12. In the flow chart of FIG. 12, in addition to the processes of steps S10 to S17 in FIG. 6, a process of step S25 and a process of step S26 are executed between steps S13 and S14.

That is, the first controller 50a obtains the image data of the inverted image B and the print mode of the printing process therefor (steps S10 and S11). In a case where the first controller 50a determines that the print mode is the first print mode (step S12: NO), the first controller 50a executes the printing process in the first print mode with the printer part 12 (step S16) and outputs the first transfer condition corresponding to the first print mode (step S17). Since the transfer energy of this first transfer condition is small, a reduction in the transfer cost can be achieved.

In a case where the first controller 50a determines that the print mode is the second print mode in step S12 (step S12: YES), the first controller 50a executes the usage amount reducing process (step S13). Further, the first controller 50a executes the pixel obtaining process (step S25). In the pixel obtaining process, the first controller 50a obtains color values of a plurality of pixels constituting the inverted image B, which is a print image, based on the image data, and determines whether or not each of the color values is closer to black than the first color value. In a case where the first controller 50a determines that the color value is closer to black than the first color value, the first controller 50a determines the pixel to be a dark pixel, and stores identification information such as position information of the pixel in the first memory 52a.

Then, the first controller 50a executes the conversion process on the image data. Further, the first controller 50a executes the color substituting process on the image data (step S26). In the color substituting process, the first controller 50a obtains the color value of the dark pixel based on the image data and the pixel identification information stored in the first memory 52a, and uses the black of the single color composed of the black ink as a black color component of the dark pixel rather than mixing the color composed of the cyan ink, magenta ink, and yellow ink.

In such a manner, the first controller 50a generates image data for the second print mode and transmits the image data to the second controller 50b. The second controller 50b executes the printing process in the second print mode based on this image data, and prints the inverted image B on the medium M (step S14). Further, the first controller 50a outputs the second transfer condition corresponding to the second print mode as the transfer condition (step S15).

In such a manner, in the printing process of the second print mode, the black ink is used, instead of the plurality of kinds of color inks, in the formation of the dark pixels in the inverted image B. By using the black ink in the formation of the dark pixels in such a manner, the ink usage amount can be reduced as compared to the ink usage amount in a case where the plurality of kinds of color inks is used. Further, the dark pixels in the transferred image C to which the inverted image B is transferred are expressed darker in a case where the black ink is used than in a case where the plurality of kinds of color inks is used. For this reason, even in a case where the ink usage amount in the inverted image B is small, the decrease in the image quality of transferred image C can be reduced.

### Fourth Modification

A printing apparatus 10 according to the fourth modification, in the third

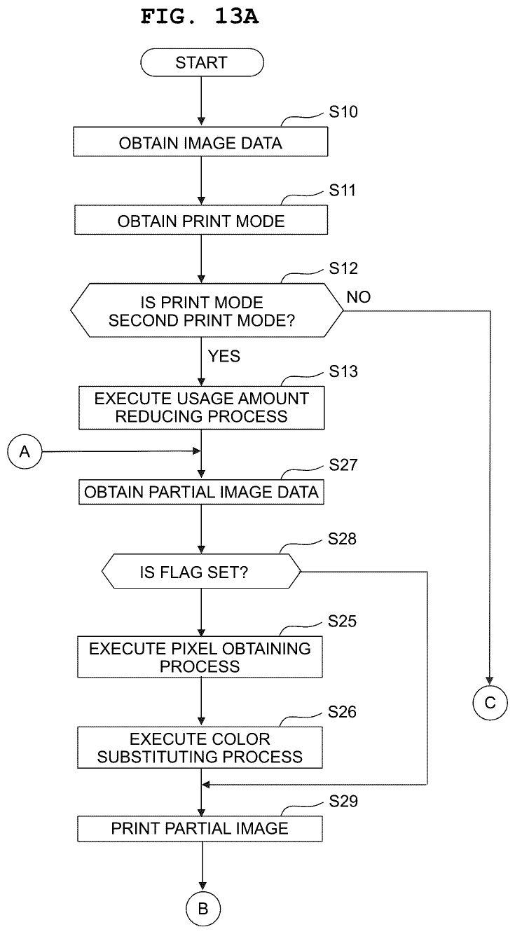

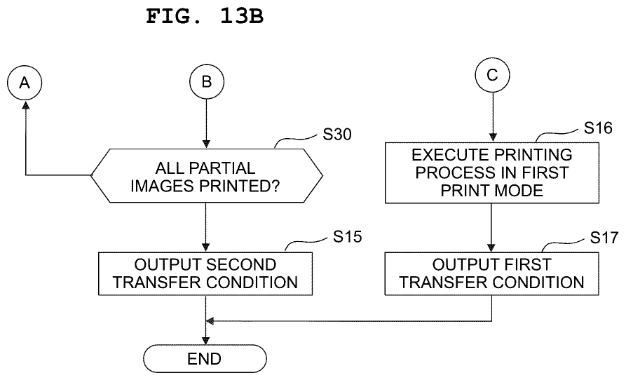

embodiment, executes the color substituting process based on the number of the dark pixels and the number of the bright pixels in the partial image F. The printing apparatus 10 is controlled by the first controller 50a and the second controller 50b, as the controller 50, in accordance with a flow chart depicted in an example of FIGS. 13A and 13B. In the flow chart of FIGS. 13A and 13B, in addition to the processes of steps S10 to S13 and S15 to S17 in FIG. 6, processes of steps S25 to S30 are executed between these steps S13 and S15.

That is, the first controller 50a obtains the image data and the print mode of the inverted image B (steps S10 and S11), and in a case where the first controller 50a determines that the print mode is the first print mode (step S12: NO), the first controller 50a executes the printing process in the first print mode with the printer part 12 (step S16), and outputs the first transfer condition corresponding to the first print mode (step S17). Since the transfer energy of the first transfer condition is small, the reduction in the transfer cost can be achieved.

In a case where the first controller 50a determines that the print mode is the second print mode in step S12 (step S12: YES), the first controller 50a executes the usage amount reducing process on the image data (step S13). Then, the first controller 50a obtains partial image data of a part of the image data (step S27), and determines whether a flag is set for the partial image data (step S28).

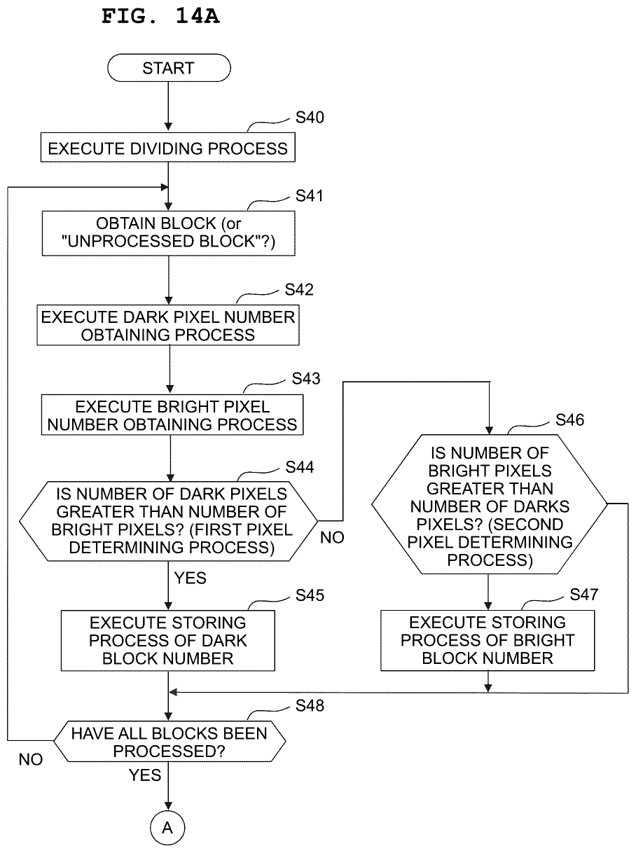

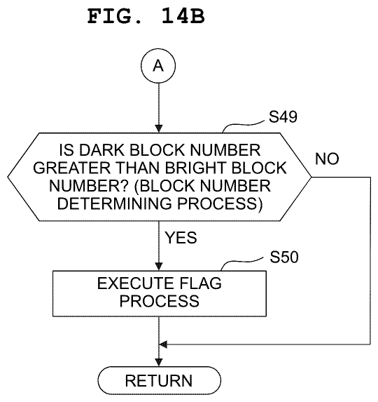

A process related to the flag is executed by the first controller 50a in accordance with a flow chart of FIGS. 14A and 14B. That is, the first controller 50a executes a dividing process of dividing the partial image F into a plurality of blocks F1 based on the partial image data, as depicted in FIG. 15 (step S40). Then, the first controller 50a obtains an unprocessed one block F1 from the plurality of blocks F1 (step S41), obtains a color value for each of a plurality of pixels belonging to this block F1, and determines whether or not the color value is closer to black than the first color value. Then, the first controller 50a executes a dark pixel number obtaining process of obtaining the number of dark pixels of which color value is closer to black than the first color value, from among the plurality of pixels belonging to the block F1 (step S42).

Further, the first controller 50a determines, regarding each of the plurality of pixels belonging to this block F1, whether or not the color value of each of the plurality of pixels belonging to this block F1 is closer to white than the second color value. Then, the first controller 50a executes a bright pixel number obtaining process of obtaining the number of bright pixels of which color value is closer to white than the second color value, from among the plurality of pixels belonging to block F1 (step S43).

Then, the first controller 50a executes a first pixel determining process of determining whether or not the number of the dark pixels in the block F1 is greater than the number of the bright pixels in the block F1 (step S44). Here, in a case where the first controller 50a determines that, in the block F1, the number of the dark pixels is greater than the number of the bright pixels (step S44: YES), the first controller 50a determines this block F1 to be a dark block, increments the count of a dark block number by 1, and stores the dark block number in the first memory 52a (step S45). With this, a storing process of storing the dark block number as the number of blocks F1 in each of which the number of the dark pixels belonging to the block F1 is greater than the number of the bright pixels belonging to the block F1.

On the other hand, in a case where the first controller 50a determines that the number of the dark pixels is equal to or less than the number of the bright pixels (step S44: NO), the first controller 50a executes a second pixel determining process of determining whether or not the number of the bright pixels in the block F1 is greater than the number of the dark pixels in the block F1 (step S46). In a case where the first controller 50a determines that the number of the bright pixels is equal to the number of the dark pixels (step S46: NO), the first controller 50a proceeds to a process of step S48.

In a case where the first controller 50a determines that the number of the bright pixels is greater than the number of the dark pixels in step S46 (step S46: YES), the first controller 50a determines that this block F1 is a bright block, increments the count of a bright block number by 1, and stores the bight block number in the first memory 52a (step S47). This executes a storing process of storing the bright block number as the number of blocks F1 in each of which the number of the bright pixels belonging to the block F1 is greater than the number of the dark pixels belonging to the block F1.

Further, the first controller 50a determines whether or not the process has been performed for all the plurality of blocks F1 included in the partial image F (step S48). In a case where the first controller 50a determines that an unprocessed block F1 remains (step $48: NO), the first controller 50a returns to the process of step S41 and executes the process of step S41 and the subsequent processes thereto. On the other hand, in a case where the first controller 50a determines that the process has been performed for all the plurality of blocks F1 included in the partial image F (step S48: YES), the first controller 50a executes a block number determining process of determining whether or not the dark block number stored by the storing process is greater than the bright block number stored by the storing process (step S49).

Here, in a case where the first controller 50a determines that the dark block number is greater than the bright block number (step S49: YES), the first controller 50a executes a flag process of setting a flag for this partial image F (step S50). The flag for the partial image F is stored in the first memory 52a. On the other hand, in a case where the first controller 50a determines that the dark block number is equal to or less than the bright block number (step S49: NO), the flag cannot be set for the partial image F.

The first controller 50a returns to the process of step S28 in FIG. 13A and determines whether or not the flag is set for the partial image F of the partial image data. Here, in a case where the first controller 50a determines that the flag is set for the partial image F (step S28: YES), the first controller 50a executes the pixel obtaining process on the partial image data and stores the identification information of each of the dark pixels in the partial image F in the first memory 52a (step S25). Then, the first controller 50a executes the conversion process on the image data, and further executes the color substituting process on the image data (step S26). With this, the black color component of each of the dark pixels is changed from the black of the mixed color by the plurality of kinds of color inks to the black of the single color by the black ink.

In a case where the first controller 50a determines that the flag is not set for the partial image F in step S28 (step S28: NO), the first controller 50a does not execute the pixel obtaining process of step S25 and the color substituting process of step S26. With this, the black color component of each of the dark pixels is not converted from the black of the mixed color by the plurality of kinds of color inks to the black of the single color by the black ink.

In such a manner, the first controller 50a generates partial image data in the print format for the second print mode and transmits the partial image data to the second controller 50b. The second controller 50b executes the printing process in the second print mode based on this partial image data, and prints the partial image F of the inverted image B on the medium M (step S29). Then, the first controller 50a determines whether or not all the plurality of partial images F constructing the print image have been printed (step S30). Here, in a case where the first controller 50a determines that a partial image F which has not been printed remains (step S30: NO), the first controller 50a returns to the process of step S27 and executes the process of step S27 and the subsequent processes thereto. On the other hand, in a case where the first controller 50a determines that all the plurality of partial images F have been printed (step S30: YES), the inverted image B of the print image constructed by all the plurality of partial images F is printed on the medium M. Then, the first controller 50a outputs the second transfer condition corresponding to the second print mode as the transfer condition (step S15).

### Fourth Embodiment

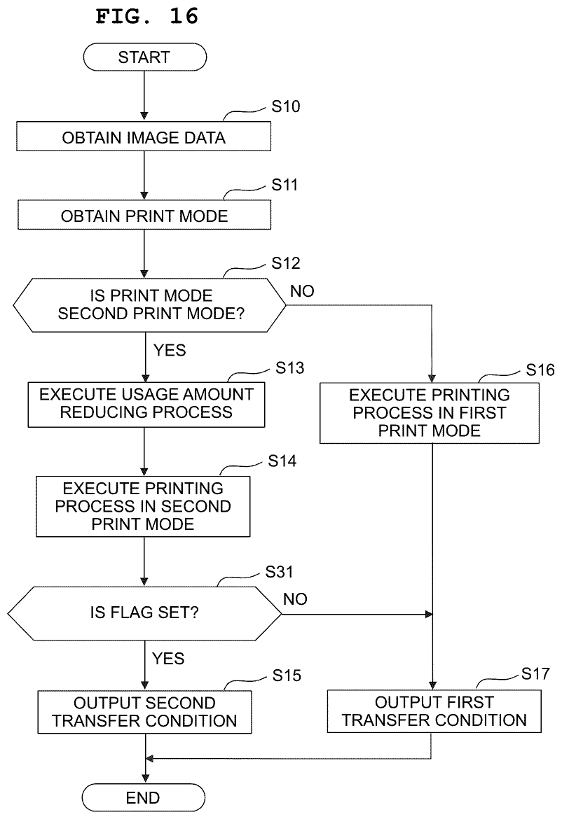

In a printing apparatus 10 according to the fourth embodiment, in the first embodiment to the third embodiment and the first modification to the fourth modification, the transfer condition is determined based on the number of the dark pixels and the number of the bright pixels in the print image. In this case, the printing apparatus 10 is controlled by the first controller 50a and the second controller 50b, as the controller 50, in accordance with a flow chart depicted in an example of FIG. 16. In the flow chart of FIG. 16, in addition to the processes of steps S10 to S17 in FIG. 6, a process of step S31 is executed between steps S14 and S15.

That is, the first controller 50a obtains the image data and the print mode of the inverted image B which is the print image (steps S10 and S11), and in a case where the first controller 50a determines that the print mode is the second print mode (step S12: YES), the first controller 50a executes the usage amount reducing process on the image data (step S13), and the second controller 50b executes the printing process in the second print mode so as to print the inverted image B on the medium M (step S14). Then, the first controller 50a determines whether or not a flag is set for this inverted image B (step S31).

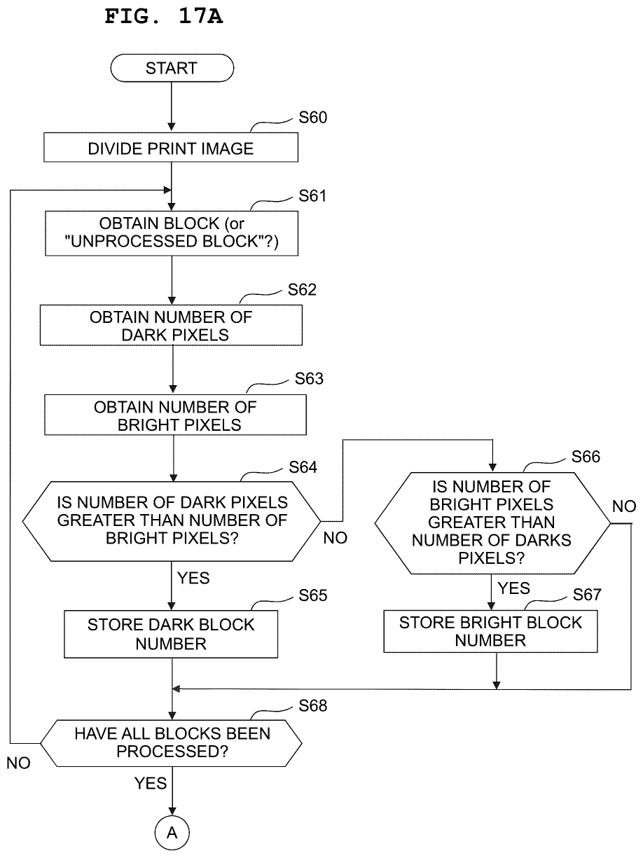

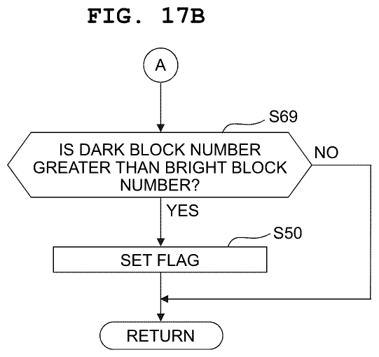

A process related to this flag is executed by the first controller 50a in accordance with the flow chart of FIGS. 17A and 17B. That is, the first controller 50a divides the print image into a plurality of blocks based on the image data (step S60), and obtains an unprocessed one block from the plurality of blocks (step S61). A block of the plurality of blocks is a partial area of the print image. Then, the first controller 50a obtains a color value for each of a plurality of pixels belonging to the block, and determines whether or not the color value is closer to black than the first color value. In a case where the first controller 50a determines that the color value of a pixel, of the plurality of pixels, is closer to black than the first color value, the first controller 50a determines the pixel having the color value to be a dark pixel and obtains the number of dark pixels in the block (step S62).

Further, the first controller 50a determines whether or not the color value of each of the plurality of pixels belonging to this block is closer to white than the second color value. In a case where the first controller 50a determines that the color value of a pixel, of the plurality of pixels, is closer to white than the second color value, the first controller 50a determines the pixel of the color value to be a bright pixel and obtains the number of bright pixels in the block (step S63). In such a manner, a pixel number obtaining process is executed so as to obtain, based on the image data, the number of the dark pixels of which color value is closer to black than the first color value and the number of the bright pixels of which color value is closer to white than the second color value, from among the pixels of the print image.

Then, the first controller 50a determines whether or not the number of the dark pixels belonging to the block is greater than the number of the bright pixels belonging to the block (step S64). Here, in a case where the first controller 50a determines that, in a block of the plurality of blocks, the number of the dark pixels is greater than the number of the bright pixels (step S64: YES), the first controller 50a determines this block to be a dark block, increments the count of a dark block number as the number of dark blocks by 1, and stores the dark block number in the first memory 52a (step S65). With this, an area number obtaining process of obtaining the number of dark blocks (dark areas), in the print image, in each of which the number of the dark pixels is greater than the number of the bright pixels is executed.

On the other hand, in a case where the first controller 50a determines that the number of the dark pixels is equal to or less than the number of the bright pixels in a block of the plurality of blocks (step S64: NO), the first controller 50a determines whether or not the number of the bright pixels belonging to the block is greater than the number of the dark pixels belonging to the block (step S66). Here, in a case where the first controller 50a determines that the number of the bright pixels is the same as the number of the dark pixels (step S66: NO), the first controller 50a proceeds to a process of step S68.

In a case where the first controller 50a determines that the number of the bright pixels is greater than the number of the dark pixels in step S66 in the block (step S66: YES), the first controller 50a determines the block to be a bright block, increments the count of a bright block number as the number of bright blocks by 1, and stores the bright block number in the first memory 52a (step S67). With this, an area number obtaining process of obtaining the number of the bright blocks (bright areas), in the print image, in each of which the number of the bright pixels is greater than the number of the dark pixels is executed.

Then, the first controller 50a determines whether or not the process has been performed for all the plurality of blocks included in the print image (step S68). In a case where the first controller 50a determines that an unprocessed block remains (step S68: NO), the first controller 50a returns to the process of step S61 and executes the process of step S61 and the subsequent processes thereto. On the other hand, in a case where the first controller 50a determines that the process has been performed for all the plurality of blocks included in the print image (step S68: YES), the first controller 50a determines whether or not the dark block number stored in the first memory 52a is greater than the bright block number stored in the first memory 52a (step S69). With this, an area determining process of determining whether or not the dark block number (the number of dark areas) is greater than the bright block number (the number of bright areas) is executed.

Here, in a case where the first controller 50a determines that the dark block number is greater than the bright block number (step S69: YES), the first controller 50a sets a flag for the print image (step S70). The flag for the print image is stored in the first memory 52a. On the other hand, in a case where the first controller 50a determines that the dark block number is equal to or less than the bright block number (step S69: NO), the flag cannot be set for the print image.

The first controller 50a returns to the process of step S31 in FIG. 16 and determines whether or not the flag is set for the print image. Here, in a case where the first controller 50a determines that the flag is set for the print image (step S31: YES), the hue of the print image is dark. Therefore, the first controller 50a outputs the second transfer condition corresponding to the second print mode as the transfer condition (step S15). With this, even in a case where the hue of the inverted image B, which is the print image, is dark and the decrease in the density due to the reduction in the amount of the ink is likely to be conspicuous, the inverted image B is transferred under the second transfer condition with the transfer energy greater than the transfer energy in the first transfer condition. Therefore, the small amount of the ink due to the transfer is compensated, and the decrease in the image quality of the transferred image C transferred to the transfer medium E can be reduced.

On the other hand, in a case where the first controller 50a determines that the flag is not set for the print image (step S31: NO), the hue of the print image is bright. Therefore, the first controller 50a outputs the first transfer condition corresponding to the first print mode, as the transfer condition (step S17). With this, in a case where the hue of the inverted image B, which is the print image, is bright and the decrease in the density due to the small amount of the ink is less likely to be conspicuous, the inverted image B is transferred under the first transfer condition, with the transfer energy smaller than the transfer energy in the second transfer condition. With this, the transfer cost can be reduced.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

In the above-described embodiments and modifications, although the printing apparatus 10 is constructed of the information processing part 11 and the printer part 12 which are included separately in the printing apparatus 10, the printing apparatus 10 may be constructed of the information processing part 11 and the printer part 12 which are included integrally in the printing apparatus 10. In this case, the controller 50 of the printing apparatus 10 may be constructed of one device, or may be constructed of a plurality of devices which operate in cooperation with each other.

What is claimed is:

1. A printing apparatus comprising:
a head configured to eject an ink having a sublimating property; and
a controller, wherein
the controller is configured to control the head so as to execute ejecting the ink from the head to a medium based on image data and in accordance with one mode selected from a print mode including a first print mode and a second print mode, an usage amount of the ink being smaller than in the first print mode, and
the controller is configured to control the head so as to execute outputting, as a transfer condition for transferring a print image printed on the medium to a transfer medium, a second transfer condition rather than a first transfer condition, in a case where the one mode selected from the print mode is the second print mode, a transfer energy for transferring the print image from the medium to the transfer medium being greater in the second transfer condition than in the first transfer condition.

2. The printing apparatus according to claim 1, wherein
the controller is configured to execute determining whether the transfer medium has a heat-resisting property, and
in a case where the controller determines that the transfer medium does not have the heat-resisting property, the controller is configured to execute outputting the first transfer condition as the transfer condition.

3. The printing apparatus according to claim 1, wherein
the print mode of the printing process includes a third print mode different from the first print mode and the second print mode, the third print mode being for forming the print image of a fine line,
the transfer condition includes a third transfer condition, the transfer energy being smaller than in the first transfer condition, and
the controller is configured:
to execute determining whether the one mode selected from the print mode is the third print mode; and
in a case where the controller determines that the one mode selected from the print mode is the third print mode, to execute outputting the third transfer condition as the transfer condition.

4. The printing apparatus according to claim 1, further comprising a moving device configured to move the head along a moving direction, wherein
the controller is configured:
to execute determining whether the one mode selected from the print mode is the second print mode;
in a case where the controller determines that the one mode selected from the print mode is the second print mode, to control the head and the moving device so as to execute a bidirectional printing of ejecting the ink from the head in a forward route and a return route of the moving direction; and
in a case where the controller determines that the one mode selected from the print mode is not the second print mode, to control the head and the moving device so as to execute a unidirectional printing of ejecting the ink from the head in the forward route or the return route of the moving direction and not ejecting the ink from the head in other routes.

5. The printing apparatus according to claim 1, further comprising a moving device configured to move the head along a moving direction, wherein
the controller is configured:
to execute determining whether the one mode selected from the print mode is the second print mode;
in a case where the controller determines that the one mode selected from the print mode is the second print mode, to control the head and the moving device so as to execute a bidirectional printing of ejecting the ink from the head in a forward route and a return route of the moving direction; and
in a case where the controller determines that the one mode selected from the print mode is not the second print mode, to control the head and the moving device so as to execute determining whether to cause the head to eject the ink in the forward route or the return route of the moving direction, based on a color difference between an image formed by ejecting the ink from the head in the forward route of the moving direction and an image formed by ejecting the ink from the head in the return route of the moving direction.

6. The printing apparatus according to claim 1, wherein
the head has first nozzles and second nozzle, each of the first nozzles being configured to eject one of a plurality of kinds of color inks including two or more kinds of color inks capable of being mixed so as to express black, and the second nozzle being configured to eject a black ink, and
the controller is configured:
to execute determining whether the one mode selected from the print mode is the second print mode;
to execute obtaining, based on the image data, a dark pixel having a color value closer to the black than a first color value from among a plurality of pixels of the print image; and
in a case where the controller determines that the one mode selected from the print mode is the second print mode, to execute using the black ink rather than mixing the plurality of kinds of color inks, so as to form the dark pixel.

7. The printing apparatus according to claim 6, further comprising a moving device configured to move the head along a moving direction, wherein
the controller is configured to control the head and the moving device so as to execute:
causing the head to eject the ink while moving the head along the moving direction based on partial image data, thereby forming a partial image, wherein the partial image data is a part of the image data, and the partial image is a part of the print image;
determining whether the one mode selected from the print mode is the second print mode;
dividing the partial image into a plurality of blocks based on the partial image data;
obtaining the number of a dark pixel having a color value closer to the black than a first color value from among a plurality of pixels belonging to a certain block included in the plurality of blocks;
obtaining the number of a bright pixel having a color value closer to white than a second color value from among the plurality of pixels belonging to the certain block;
determining whether the number of the dark pixel in the certain block is greater than the number of the bright pixel in the certain block;
determining whether the number of the bright pixel in the certain block is greater than the number of the dark pixel in the certain block;
storing a dark block number representing the number of a dark block, included in the plurality of blocks and a bright block number representing the number of a bright block, included in the plurality of blocks, wherein the number of the dark pixel belonging to the block is greater than the number of the bright pixel belonging to the block, and the number of the bright pixel belonging to the block is greater than the number of the dark pixel belonging to the block;
determining whether the dark block number stored is greater than the bright block number stored; and
setting a flag in a case where the controller determines that the dark block number is greater than the bright block number, and
in a case where the flag is set and the controller determines that the one mode selected from the print mode is the second print mode, the controller is configured to execute using the black ink rather than mixing the plurality of kinds of color inks, so as to form the dark pixel.

8. The printing apparatus according to claim 1, wherein
the head includes first nozzles including nozzles each configured to eject one of a plurality of kinds of color inks including two or more kinds of color inks is to be mixed to express black, and a second nozzle configured to eject a black ink, and
the controller is configured to execute:
determining whether the one mode selected from the print mode is the second print mode;
obtaining the number of a dark pixel having a color value closer to the black than a first color value, and the number of a bright pixel having a color value closer to white than a second color value from among a plurality of pixels of the print image, based on the image data;
obtaining, from the print image, the number of a dark area and the number of a bright area, wherein the number of the dark pixel is greater than the number of the bright pixel, and the number of the bright pixel is greater than the number of the dark pixel; and
determining whether the number of the dark area is greater than the number of the bright area,
in a case where the controller determines that the number of the dark area is greater than the number of the bright area and where the controller determines that the one mode selected from the print mode is the second print mode, the controller is configured to output the second transfer condition, as the transfer condition, and
in a case where the controller determines that the number of the dark area is equal to or less than the number of the bright area and where the controller determines that the one mode selected from the print mode is the second print mode, the controller is configured to execute outputting the first transfer condition as the transfer condition.

9. A control method of controlling a printing apparatus including a head configured to eject an ink having a sublimating property, the control method comprising causing the printing apparatus:
to execute ejecting the ink from the head to a medium based on image data and in accordance with one mode selected from a print mode including a first print mode and a second print mode, a usage amount of the ink in the second print mode being smaller than a usage amount of the ink in the first print mode; and
in a case where the one mode selected from the print mode is the second print mode, to execute outputting, as a transfer condition for transferring a print image printed on the medium to a transfer medium, a second transfer condition rather than a first transfer condition, a transfer energy for transferring the print image from the medium to the transfer medium being greater in the second transfer condition than in the first transfer condition.

10. A non-transitory and computer-readable medium storing a program for controlling a printing apparatus including a head configured to eject an ink having a sublimating property, the program causing the printing apparatus:
to execute ejecting the ink from the head to a medium based on image data and in accordance with one mode selected from a print mode including a first print mode and a second print mode, an usage amount of the ink in the second print mode being smaller than an usage amount of the ink in the first print mode; and
in a case where the one mode selected from the print mode is the second print mode, to execute outputting, as a transfer condition for transferring a print image printed on the medium to a transfer medium, a second transfer condition rather than a first transfer condition, a transfer energy for transferring the print image from the medium to the transfer medium being greater in the second transfer condition than in the first transfer condition.
